(19) United States
(12) Patent Application Publication
(10) Pub. No.: US 2019/0346717 A1
(43) Pub. Date: Nov. 14, 2019

(54) COLOR FILM SUBSTRATE, PREPARATION METHOD THEREOF, AND DISPLAY APPARATUS

(71) Applicant: Shenzhen China Star Optoelectronics Semiconductor Display Technology Co., Ltd., Shenzhen (CN)

(72) Inventor: ZHIXIONG JIANG, SHENZHEN (CN)

(21) Appl. No.: 16/211,256

(22) Filed: Dec. 6, 2018

Related U.S. Application Data
(63) Continuation of application No. PCT/CN2018/111404, filed on Oct. 23, 2018.

(30) Foreign Application Priority Data
May 8, 2018 (CN) 201810433296.4

(51) Int. Cl. G02F 1/1335; G02F 1/1339

(52) U.S. Cl. CPC G02F 1/133514; G02F 1/133512; G02F 2001/13398; G02F 2001/133519; G02F 1/13394

(57) ABSTRACT

The present disclosure provides a color film substrate, a preparation method thereof, and a display apparatus. The color film substrate may include: a base substrate; a composite layer arranged on the base substrate, and including a plurality of black matrices and a plurality of first over coats which are arranged alternately, and the plurality of first over coats at least filled between the plurality of black matrices; a color filter layer formed on the composite layer; a second over coat formed on the color filter layer; a post spacer formed on the second over coat. Flatness of a surface of the color filter layer may be improved, a gap between the color filter layer and an overlapping portion of the black matrix may be reduced, and quality of a liquid crystal display may be improved.

### CROSS-REFERENCE TO RELATED APPLICATIONS

The present application is a continuation-application of International (PCT) Patent Application No. PCT/CN2018/111404, filed on Oct. 23, 2018, which claims foreign priority of Chinese Patent Application No. 201810433296.4, filed on May 8, 2018 in the State Intellectual Property Office of China, the entire contents of which are hereby incorporated by reference.

### FIELD

The described embodiments relate to a display technology, and more particularly, to a color film substrate, a preparation method thereof, and a display apparatus.

### BACKGROUND

A color filter substrate and an array substrate and liquid crystals between the color filter substrate and the array substrate are main components of a liquid crystal display apparatus. The array substrate provides a stable electric field for a liquid crystal deflection, and the color filter substrate provides a colorization processing for light transmitted through deflected liquid crystals.

In general, a color film (CF) includes a substrate, a black matrix (BM), a color filter, an over coat (OC), and a post spacer (PS). A preparation process may include: forming a pattern of a black matrix on the base substrate, forming a pattern including red, green and blue color filter layers, forming an over coat on the black matrix and the color filter layer, and forming post spacers on the over coat.

In order to prevent a light leakage, the color filter layer pattern and the black matrix have a certain overlap. Therefore, after the color filter layer is filled in a grid frame of the black matrix. Actually, a surface of the color filter layer is a curved structure. A gap generated by an overlapping portion and the curved structure of the color filter layer make the color filter layer concave. In severe cases, the deflection of the liquid crystal at the gap place may be deviated, which affects image quality of a displayed product.

### SUMMARY

The present disclosure provides a color film substrate, a preparation method thereof, and a display apparatus. Flatness of a surface of the color filter layer may be improved, a gap between the color filter layer and an overlapping portion of the black matrix may be reduced, and quality of a liquid crystal display may be improved.

In order to solve the above-mentioned technical problem, a technical solution adopted by the present disclosure is to provide a color film substrate including: a base substrate; a composite layer arranged on the base substrate, and including a plurality of black matrices and a plurality of first over coats which are arranged alternately, wherein the plurality of first over coats are at least filled between the plurality of black matrices, and a thickness of the plurality of first over coats and a thickness of the plurality of black matrices are same; a color filter layer formed on the composite layer; a second over coat formed on the color filter layer; a post spacer formed on the second over coat; wherein the plurality of first over coats and the second over coat are made of a transparent photoresist material.

In order to solve the above-mentioned technical problem, a technical solution adopted by the present disclosure is to provide a preparing method for color film substrate, including: preparing a composite layer on the base substrate; the composite layer including a plurality of black matrices and a plurality of first over coats which are arranged alternately, and the plurality of first over coats at least filled between the plurality of black matrices; preparing sequentially a patterned color filter layer, a second over coat, and a post spacer on the composite layer.

In order to solve the above-mentioned technical problem, a technical solution adopted by the present disclosure is to provide a display apparatus including a color film substrate, and the color film substrate including: a base substrate; a composite layer arranged on the base substrate, and including a plurality of black matrices and a plurality of first over coats which are arranged alternately; the plurality of first over coats at least filled between the plurality of black matrices; a color filter layer formed on the composite layer; a second over coat formed on the color filter layer; a post spacer formed on the second over coat.

Advantages of the disclosure may follow. As compared with the related art, the present disclosure may provide a color film substrate, a preparation method thereof, and a display apparatus, to subject a flattening process to a patterned black photoresist, so that flatness of a surface of the color filter layer may be improved, a gap between the color filter layer and an overlapping portion of the black matrix may be reduced, and quality of a liquid crystal display may be improved.

### BRIEF DESCRIPTION OF THE DRAWINGS

FIG. 1 is a flow chart of a preparation method for a color film substrate in accordance with an embodiment in the present disclosure.

FIG. 2 is a schematic illustration of a preparation method shown in FIG. 1 in accordance with an embodiment in the present disclosure.

FIG. 3 is a flow chart of the block S10 shown in FIG. 1 in accordance with an embodiment in the present disclosure.

FIG. 4 is a flow chart of a preparation method for a color film substrate in accordance with an embodiment in the present disclosure.

FIG. 5 is a schematic illustration of a preparation method shown in FIG. 4 in accordance with an embodiment in the present disclosure.

FIG. 6 is a structure illustration of a color film substrate shown in FIG. 1 in accordance with an embodiment in the present disclosure.

FIG. 7 is a structure illustration of a color film substrate shown in FIG. 4 in accordance with an embodiment in the present disclosure.

FIG. 8 is a structure illustration of a display apparatus in accordance with an embodiment in the present disclosure.

### DETAILED DESCRIPTION

The detailed description set forth below is intended as a description of the subject technology with reference to the appended figures and embodiments. It is understood that the embodiments described herein include merely some parts of the embodiments of the present disclosure, but do not include all the embodiments. Based on the embodiments of the present disclosure, all other embodiments that those skilled in the art may derive from these embodiments are within the scope of the present disclosure.

Referring to FIG. 1, FIG. 1 is a flow chart of a preparation method for a color film substrate in accordance with an embodiment in the present disclosure. The preparation method may include the following blocks.

Block S10: a composite layer may be prepared on a base substrate. The composite layer may include a plurality of black matrices and a plurality of first over coats which are arranged alternately. The plurality of first over coats may be at least filled between the plurality of black matrices.

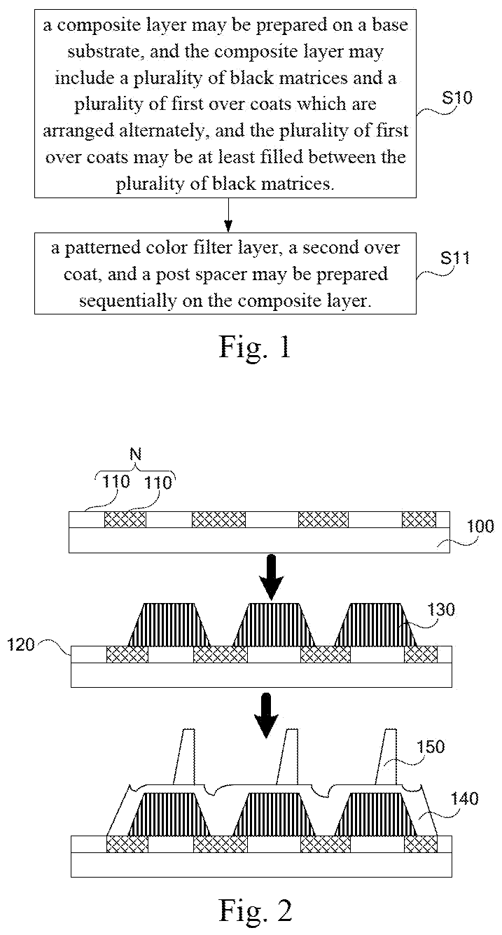

Referring to FIG. 1 and FIG. 2, FIG. 2 is a schematic illustration of a preparation method shown in FIG. 1 in accordance with an embodiment in the present disclosure. In the block S10, a base substrate 100 may be provided. The base substrate 100 may be a transparent material, and may be a substrate made of a material such as glass, ceramic, or transparent plastic, it is not limited herein. A composite layer N may be prepared on the base substrate 100. The composite layer N may include a plurality of black matrices 110 and a plurality of first over coats 120 which are arranged alternately. The plurality of first over coats 120 may be at least filled between the plurality of black matrices 100. In this embodiment, the plurality of first over coats 120 may be filled in a grid frame formed between plurality of black matrices 110, and a thickness of the plurality of first over coats 120 and a thickness of the plurality of black matrices 110 may be same.

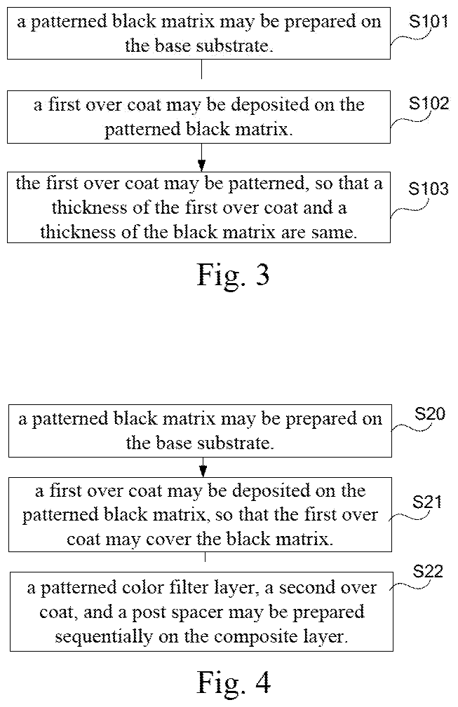

Referring to FIGS. 1 to 3, FIG. 3 is a flow chart of the block S10 shown in FIG. 1 in accordance with an embodiment in the present disclosure the block 10 may include the following blocks.

Block S101: a patterned black matrix may be prepared on the base substrate.

Further, a patterned black matrix 110 may be prepared on the base substrate 100, and a grid frame surrounded by the black matrix 110 may form a pixel region. The black matrix 110 may be mainly configured to divide adjacent color resistances, and block gaps between colors, so that light leakage or color mixing may be prevented and a contrast of color may be increased. In the present disclosure, the black matrix 110 may generally adopt a negative photoresist, and a patterning process of the black matrix 110 may be generally performed by a photolithography process, i.e., it may be processed by a mask to obtain a required pattern. The photolithography process may refer to the preparation method in the related art, therefore no additional description for similarities is given herebelow.

Block S102: a first over coat may be deposited on the patterned black matrix.

In this embodiment, after the patterned black matrix 110 is prepared, a first over coat 120 may be further deposited on the base substrate 100 including the patterned black matrix 110. The first over coat 120 may be made of a transparent photoresist material, such as a positive paraformaldehyde (PFA) material or other positive photoresist materials, and it is not further limited herein.

Block S103: the first over coat may be patterned, so that a thickness of the first over coat and a thickness of the black matrix are same.

The first over coat 120 may be further patterned to make a patterning of the first over coat and a patterning of the black matrix complementary. In this embodiment, the patterning process of the first over coat 120 may share a mask with the patterning process of the black matrix, thereby the cost of a mask may be saved, and the cost of the patterning process may be reduced.

In this embodiment, by subjecting a flattening process to the black matrix 110, the flat first over coat 120 may be be obtained, and the thickness of the first over coat 120 and the thickness of the black matrix 110 may be same. By the above-mentioned processes, flatness of a surface of a subsequent color filter layer may be ensured, so that flatness of a surface of the subsequent color filter layer may be improved, a gap between the color filter layer and an overlapping portion of the black matrix may be reduced, and quality of a liquid crystal display may be improved.

Block S11: a patterned color filter layer, a second over coat, and a post spacer may be prepared sequentially on the composite layer.

After the flattening process, a color filter layer 130, a second over coat 140, and a post spacer 150 may be prepared sequentially on the patterned black matrix 110 (i.e., the composite layer N). The color filter layer 130 may be formed on the patterned first over coat 120 and may be formed on the patterned black matrix 110, and the color filter layer 130 may at least partially overlap the black matrix 110.

Compared with the related art, the color filter layer may be filled in a grid frame formed by a black matrix, and a surface the color filter layer may be curved. In the present disclosure, because the first over coat 120 may be formed by the flattening process after the black matrix 110 is prepared, the first over coat 120 may improve the gap of the color filter layer 130 and may ensure the flatness of the surface of the color filter layer 130, thereby quality of a liquid crystal display may be improved.

The second over coat 140 may also be made of the same material as the first over coat 120, i.e., a transparent photoresist material. When the color filter substrate is used to prepare a display device, a gap between the color filter substrate and the array substrate needs to be maintained at a stable distance. Therefore, the spacer 150 may be usually formed on an opposite side of the color filter substrate from the array substrate to obtain a stable support between the color filter substrate and the array substrate. The spacer 150 may be located behind a pixel region of the column in which the color filter layer 130 is located.

In the above-mentioned embodiment, by subjecting a flattening process to a patterned black photoresist, so that flatness of a surface of the color filter layer may be improved, a gap between the color filter layer and an overlapping portion of the black matrix may be reduced, and quality of a liquid crystal display may be improved.

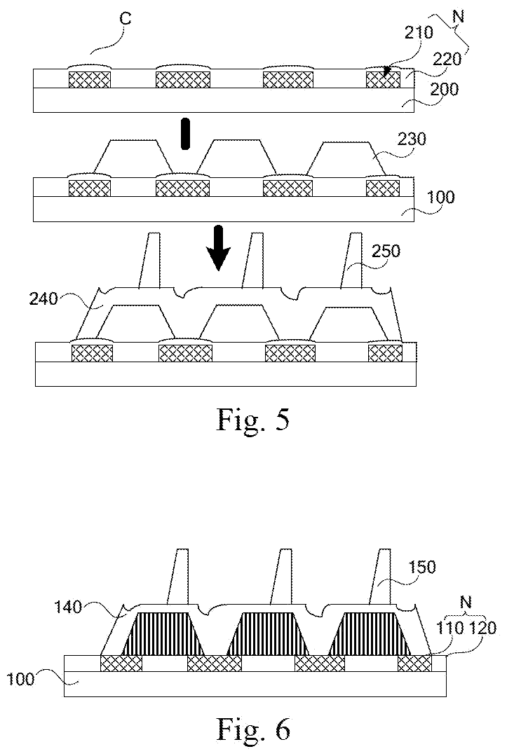

Referring to FIG. 4 and FIG. 5, FIG. 4 is a flow chart of a preparation method for a color film substrate in accordance with an embodiment in the present disclosure, and FIG. 5 is a schematic illustration of a preparation method shown in FIG. 4 in accordance with an embodiment in the present disclosure.

This embodiment is further extended on the basis of the above-mentioned embodiment of the color filter substrate, and is substantially the same as the first embodiment, therefore no additional description for similarities is given herebelow. This embodiment may include the following blocks.

Block S20: a patterned black matrix may be prepared on the base substrate.

S21: a first over coat may be deposited on the patterned black matrix, so that the first over coat may cover the black matrix.

In this embodiment, after the patterned black matrix 210 is prepared, a first over coat 220 may be further deposited on the base substrate 200 having the patterned black matrix 110. The first over coat 220 may be made of a transparent photoresist material such as a positive or negative PFA material, or a SU-8 photoresist, and it is not further limited herein. The different from this embodiment and the above-mentioned embodiment is that, after first over coat 220 is formed, the first over coat 220 is not subjected a pattern process, but a convex structure C may be formed at a position where the first over coat 220 corresponds to the black matrix 210. In the subsequent process of the color filter layer 230, because a thickness of the convex structure C is smaller than a thickness of the black matrix, flatness of a surface of a subsequent color filter layer 230 may be ensured, and a gap between the color filter layer 230 and an overlapping portion of the black matrix 210 may be reduced, and quality of a liquid crystal display may be improved. In this embodiment, because the first over coat is not patterned, the exposure and development processes may be reduced in an actual preparing process, thereby the preparing process may be further reduced.

Block S22: a patterned color filter layer, a second over coat, and a post spacer may be prepared sequentially on the composite layer.

In the above-mentioned embodiment, by subjecting a flattening process to a patterned black photoresist, so that flatness of a surface of the color filter layer may be improved, a gap between the color filter layer and an overlapping portion of the black matrix may be reduced, and quality of a liquid crystal display may be improved.

Referring to FIG. 6, FIG. 6 is a structure illustration of a color film substrate shown in FIG. 1 in accordance with an embodiment in the present disclosure. As shown in FIG. 6, the color film substrate may include a base substrate 100, a composite layer N, a color filter layer 130, a second over coat 140, and a post spacer 150.

The composite layer N may be prepared on the base substrate 100. The base substrate 100 may be a transparent material, and may be a substrate made of a material such as glass, ceramic, or transparent plastic. In the present disclosure, the black matrix 110 may employ a negative photoresist.

The composite layer N may include a patterned of black matrix 114 and a first over coat 120. The first over coat 120 may be formed on the base substrate 100 and the black matrix 110. In this embodiment, the first over coat 120 may be made of a transparent photoresist material, such as a positive paraformaldehyde (PFA) material or other positive photoresist materials, and it is not further limited herein. A thickness of the first over coat 120 and a thickness of the black matrix 110 may be same.

The color filter layer 130 may be formed on the composite layer N, and the color filter layer 130 may at least partially overlap the black matrix 110 in the composite layer N.

The second over coat 140 may be formed on the color filter layer 130. The post spacer 150 may be formed on the second over coat 140.

Specific preparations of each structure in the color film substrate in this embodiment, may refer to the detailed description of the above-mentioned embodiments, and no additional description is given herebelow.

In the above-mentioned embodiment, by forming a first over coat on a black photoresist, a gap in a color filter layer may be improved, and flatness of a surface of the color filter layer may be ensured, so that quality of a liquid crystal display may be improved.

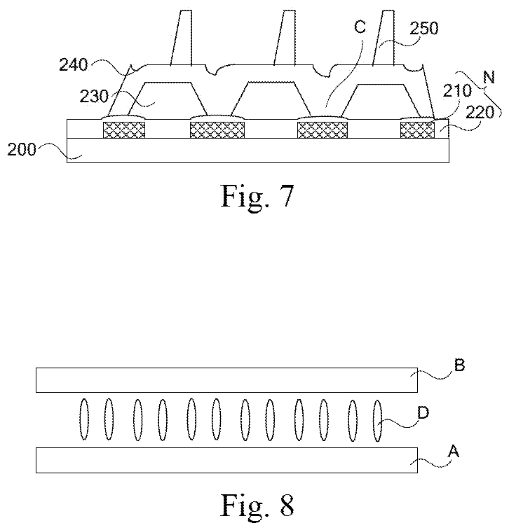

Referring to FIG. 7, FIG. 7 is a structure illustration of a color film substrate shown in FIG. 4 in accordance with an embodiment in the present disclosure. As shown in FIG. 7, the color film substrate may include a base substrate 200, a composite layer N, a color filter layer 230, a second over coat 240, and a post spacer 250.

The composite layer N may include a patterned of black matrix 210 and a first over coat 220. The black matrix 210 may be formed on the base substrate 200. The composite layer N may be prepared on the base substrate 200. The base substrate 200 may be a transparent material, or may be a substrate made of a material such as glass, ceramic, or transparent plastic. In the present disclosure, the black matrix 210 may employ a negative photoresist.

The first over coat 220 may be formed on the base substrate 200 and the black matrix 210. The first over coat 220 may be made of a transparent photoresist material such as a positive or negative PFA material, or a SU-8 photoresist, and it is not further limited herein.

In this embodiment, the first over coat 220 is not subjected a pattern process, but a convex structure C may be formed at a position where the first over coat 220 corresponds to the black matrix 210. In the subsequent process of the color filter layer 230, because a thickness of the convex structure C is smaller than a thickness of the black matrix, flatness of a surface of a subsequent color filter layer 230 may be ensured, and a gap between the color filter layer 230 and an overlapping portion of the black matrix 210 may be reduced, and quality of a liquid crystal display may be improved.

The color filter layer 230 may be formed on the composite layer N, and the color filter layer 230 may at least partially overlap the black matrix 210 in the composite layer N.

The second over coat 240 may be formed on the color filter layer 230. The post spacer 250 may be formed on the second over coat 240.

Specific preparations of each structure in the color film substrate in this embodiment, may refer to the detailed description of the above-mentioned embodiments, and no additional description is given herebelow.

In the above-mentioned embodiment, by subjecting a flattening process to a patterned black photoresist, so that flatness of a surface of the color filter layer may be improved, a gap between the color filter layer and an overlapping portion of the black matrix may be reduced, and quality of a liquid crystal display may be improved.

Referring to FIG. 8, FIG. 8 is a structure illustration of a display apparatus in accordance with an embodiment in the present disclosure. The display apparatus in the present disclosure may include a color filter substrate A, an array substrate B, and a liquid crystal layer D between the color filter substrate A and the array substrate B. The specific structure of the color filter substrate A may refer to the detailed description of the above-mentioned embodiments, and no additional description is given herebelow.

In summary, skilled in the art will readily understand that the present disclosure provides a color film substrate, a preparation method thereof, and a display apparatus. By subjecting a flattening process to a patterned black photoresist, so that flatness of a surface of the color filter layer may be improved, a gap between the color filter layer and an overlapping portion of the black matrix may be reduced, and quality of a liquid crystal display may be improved.

It is understood that the descriptions above are only embodiments of the present disclosure. It is not intended to limit the scope of the present disclosure. Any equivalent transformation in structure and/or in scheme referring to the instruction and the accompanying drawings of the present disclosure, and direct or indirect application in other related technical field, are included within the scope of the present disclosure.

What is claimed is:

1. A color film substrate comprising:
a base substrate;
a composite layer arranged on the base substrate, and comprising a plurality of black matrices and a plurality of first over coats which are arranged alternately, wherein the plurality of first over coats are at least filled between the plurality of black matrices, and a thickness of the plurality of first over coats and a thickness of the plurality of black matrices are same;
a color filter layer formed on the composite layer;
a second over coat formed on the color filter layer;
a post spacer formed on the second over coat;
wherein the plurality of first over coats and the second over coat are made of a transparent photoresist material.

2. The color film substrate according to claim 1, wherein
the color filter layer is formed on the plurality of first over coats and formed on the plurality of black matrices which are patterned, and the color filter layer at least partially overlaps the plurality of black matrices.

3. The color film substrate according to claim 1, wherein
the color filter layer is formed on the plurality of first over coats, and the plurality of first over coats cover the plurality of black matrices.

4. A preparing method for color film substrate, comprising:
preparing a composite layer on the base substrate; the composite layer comprising a plurality of black matrices and a plurality of first over coats which are arranged alternately, and the plurality of first over coats at least filled between the plurality of black matrices;
preparing sequentially a patterned color filter layer, a second over coat, and a post spacer on the composite layer.

5. The preparing method according to claim 4, wherein the preparing the composite layer on the base substrate, comprises:
preparing a patterned black matrix on the base substrate;
depositing a first over coat on the patterned black matrix;
patterning the first over coat, so that a thickness of the first over coat and a thickness of the black matrix are same.

5. The preparing method according to claim 5, wherein
the color filter layer is formed on the patterned first over coat and formed on the patterned black matrix, and the color filter layer at least partially overlaps the black matrix.

7. The preparing method according to claim 4, wherein preparing the composite layer on the base substrate, comprises:
preparing a patterned black matrix on the base substrate;
depositing a first over coat on the patterned black matrix, so that the first over coat covers the black matrix.

8. A display apparatus comprising a color film substrate, and the color film substrate comprising:
a base substrate;
a composite layer arranged on the base substrate, and comprising a plurality of black matrices and a plurality of first over coats which are arranged alternately; the plurality of first over coats at least filled between the plurality of black matrices;
a color filter layer formed on the composite layer;
a second over coat formed on the color filter layer;
a post spacer formed on the second over coat.

9. The display apparatus according to claim 8, wherein
the plurality of first over coats are at least filled between the plurality of black matrices, and a thickness of the plurality of first over coats and a thickness of the plurality of black matrices are same.

10. The display apparatus according to claim 9, wherein
the color filter layer is formed on the plurality of first over coats and formed on the plurality of black matrices which are patterned, and the color filter layer at least partially overlaps the plurality of black matrices.

11. The color film substrate according to claim 8, wherein
the color filter layer is formed on the plurality of first over coats, and the plurality of first over coats cover the plurality of black matrices.

12. The color film substrate according to claim 8, wherein
the plurality of first over coats and the second over coat are made of a transparent photoresist material.
